(19) United States
(12) Patent Application Publication
(10) Pub. No.: US 2010/0068948 A1
(43) Pub. Date: Mar. 18, 2010

(54) SERVICE SWITCHING DEVICE AND CONNECTING TERMINAL FOR A SERVICE SWITCHING DEVICE

(76) Inventors: Ralf Weber, Heidelberg (DE); Klaus-Peter Eppe, Waldbrunn (DE); Gerd Krebs, Hockenheim (DE); Gerhard Ziegler, Lobbach (DE)

Correspondence Address: DARBY & DARBY P.C., P.O. BOX 770, Church Street Station, New York, NY, 10008-0770, US

(21) Appl. No.: 12/447,597

(22) PCT Filed: Oct. 26, 2007
(86) PCT No.: PCT/EP2007/009313

§ 371 Date: Apr. 28, 2009

(30) Foreign Application Priority Data
Oct. 28, 2006 (DE) 10 2006 050 932.3
Sep. 3, 2007 (DE) 10 2007 041 650.6

(51) Int. Cl. H01R 4/38

(52) U.S. Cl. 439/801

(57) ABSTRACT

A service switching device comprises a housing having a front face, a mounting face, and a narrow face disposed between the front face and the mounting face. A connecting terminal disposed in a terminal accommodation area close to the narrow face has a terminal screw, accessible from the front face and moveable in a movement direction, including an operating end and a clamping end disposed opposite the operating end; a terminal body including at least one terminal area, in which a connecting conductor can be pressed against a busbar by the terminal screw, wherein the terminal body is accessible via a first housing opening in a wall of the narrow face; and a terminal cover part.

This is a U.S. National Phase Application under 35 U.S.C. §171 of International Application No. PCT/EP2007/009313, filed on Oct. 26, 2007, which claims priority to German Application No. DE 10 2006 050 932.3, filed on Oct. 28, 2006; and German Application No. DE 10 2007 041 650.6, filed on Sep. 3, 2007. The International Application was published in German on May 8, 2008 as WO 2008/052710 A1 under PCT 21 (2).

The invention relates to a service switching device having a housing, comprising a front face, a mounting face and a narrow face between them, and having a connecting terminal which is held in a terminal accommodation area, which is located close to the narrow face, of the housing, comprising a terminal screw, which is accessible from the front face and has an operating end and a clamping end opposite it, furthermore comprising a terminal body having at least one terminal area in which a busbar and/or a connecting conductor can be pressed against a busbar by means of the terminal screw, with the terminal body being accessible via a first housing opening in the wall of the narrow face, and in which case the at least one terminal area can be covered by a terminal cover part, which is coupled to the clamping end of the terminal screw, can be driven thereby in the movement direction of the terminal screw and is of such a size that it covers the terminal area in a touch-proof manner even while the terminal screw is screwed onto the busbar.

The invention also relates to a connecting terminal for installation in the terminal accommodation area of a service switching device.

### BACKGROUND

EP 809 325 B1 discloses a service switching device having a double chamber terminal A commercially available threaded bolt without a head is in this case screwed into the cylindrical section of a terminal body. The screw can in this case be screwed completely into the terminal body, such that it covers the supply opening in the housing. Although this means that an incorrect connection is no longer possible, it is, however, possible to inadvertently touch the terminal opening, which can lead to safety risks.

DE 44 36 780 C2 discloses a service switching device having an L-shaped terminal cover part, which is inserted in a slot on the narrow face of the service switching device and is latched in a fixed position within the slot. This is costly to manufacture and is complex to assemble.

### SUMMARY OF THE INVENTION

An aspect of the present invention is to provide a service switching device of this generic type and a connecting terminal of this generic type for a service switching device, in which the terminal cover part is mounted on the terminal screw in a manner which is simpler and can be produced at a lower cost.

Thus, according to the invention, the terminal cover part is riveted to the terminal screw such that it can rotate. It is particularly advantageous for the terminal cover part to be riveted to the terminal screw, at the clamping end of the terminal screw, such that it can rotate. This has the advantage that only one rivet pin need be fitted as an additional functional element to the terminal screw. The terminal screw therefore has a very simple rivet geometry, which means that the terminal screw can be produced easily and at low cost. The mounting of the terminal cover part by rotatable riveting on one rivet pin is also a process which can be carried out very easily and quickly, and therefore at low cost. In particular, it is therefore possible to manufacture the terminal arrangement of a service switching device according to the invention using an automatic production machine with very short cycle times, a so-called high-speed automatic production machine, as an assembly which can be removed from the automatic machine by gravity and can be mounted in a further automatic assembly machine, which likewise operates at very high speed. The particular advantage of the rotatable riveting is that, when the connecting conductor is firmly clamped, the screw does not rotate on the stripped conductor end piece. The terminal cover part can be pressed against the conductor end piece by the terminal screw and remains fixed there in the circumferential direction of the terminal screw, while the terminal screw itself can be tightened further. This avoids material being removed from the conductor end piece, which could occur if the clamping end of the terminal screw were to rotate on the conductor end piece. A further advantage of the rotatable riveting is that the terminal cover part is additionally still connected in a captive manner to the clamping end of the terminal screw.

According to one particularly advantageous embodiment, the terminal cover part is L-shaped, with a first limb being riveted to the clamping end of the terminal screw such that it can rotate, and with a second limb, which points in the direction of the front face from the first limb, covering at least the first terminal area in a touch-proof manner. The first limb of the terminal cover part therefore at the same time acts as a pressure plate for contact with the conductor, which means that no separate component need be provided for this purpose, thus achieving a further simplification of the device design.

According to a further embodiment, the second limb of the terminal cover part is narrower than the housing opening associated with the terminal area which is covered by the terminal cover part, with that part of the housing opening which is left free of the terminal cover part being so small that it is not possible to touch live device parts through it. This is particularly advantageous when the intention is to clamp connecting conductors with large conductor cross sections or connecting conductors whose conductor ends are surrounded by core end sleeves and thus have a larger cross section, in the connecting terminal. The opening in the terminal area and the housing opening associated with the terminal area must then be provided in a corresponding manner with a corresponding cross-sectional size. It is then easy for the housing opening to become so large that a human finger or standard test finger, as is normally used, to test the direct-contact protection of electrical devices, to pass through the opening and to touch live parts in the device interior or to touch the terminal. However, this is intended to be impossible in the case of service switching devices which are protected against direct contact. Known terminal cover parts therefore cover the housing opening in the area of the terminal area, over a large area. In the case of large housing openings, this necessitates correspondingly large terminal cover parts. The design of the terminal cover part according to the invention makes it possible to produce the terminal cover parts to be smaller, lighter and thus using less material. Protection against direct contact is nevertheless provided.

According to one particularly advantageous embodiment, the terminal cover part is composed of plastic. The electrical contact between the terminal screw and the connecting conductor is ensured by the clamping end of the terminal screw being compressed or bent over as a result of the riveting process on the rivet pin.

For applications in which it is undesirable for the conductor end to come into contact with plastic, it is possible, according to a further particularly advantageous embodiment, for the terminal cover part to be riveted to a metallic rivet plate on a rivet pin, which projects at the clamping end of the terminal screw, such that it can rotate.

According to a further advantageous embodiment, the terminal cover part is composed of metal, with at least the second limb being covered with an insulating material at least on the face which faces outward and can be touched.

According to one advantageous embodiment, covering with an insulating material can be achieved by plugging or clipping a plastic part, which sheaths the second limb, onto the second limb.

According to a further advantageous embodiment, the covering with an insulating material can also be achieved by shrinking an insulating shrink sleeve onto the second limb.

According to a further advantageous embodiment, the covering with an insulating material can be achieved by spraying a plastic layer onto the second limb, at least on the face which points outward and can be touched, or the second limb is insert-molded with plastic.

According to a further advantageous embodiment, the terminal screw may be a threaded bolt without a head. This is because the configuration of the operating end of the terminal screw is not of importance for the present invention, because the terminal cover part is fitted to the clamping end of the terminal screw. The use of a threaded bolt without a head offers the advantage, however, that this can be screwed very deeply and completely into the terminal body and, furthermore, is available as a very low-cost mass-produced item.

In this case, the terminal cover part according to the invention can be produced at very low cost as a mass-produced item and, during manufacture of the service switching device, can be riveted to the terminal screw, at its clamping end, such that it can rotate. When a connection conductor is inserted into the terminal and the terminal is then closed, that is to say when the terminal screw is screwed in, then the terminal cover part according to the invention covers that part of the terminal which points from the clamping end in the direction of the operating end of the terminal screw at least so far that this prevents a finger or a test finger from inadvertently touching the live terminal part between the clamping end and the operating end of the terminal screw.

According to one particular advantageous embodiment, the service switching device has a terminal body having at least two terminal areas, which are accessible via a first and a second housing opening from the wall of the narrow face which is adjacent to the front face, are located one behind the other with respect to the front face and are separated from one another by a busbar inserted into the terminal body, for connection of a busbar and/or of a connecting conductor, in which case a first terminal area, which is located between the busbar and the front face, can be covered by a terminal cover part, which is coupled to the clamping end of the terminal screw, can be driven thereby in the movement direction of the terminal screw and is of such a size that it covers the first terminal area even while the terminal screw is screwed onto the busbar, with the terminal cover part being riveted to the terminal screw such that it can rotate.

The first terminal area in this advantageous embodiment is in this case normally intended for the connection of connecting wires, and the second terminal area is intended for the connection of the connecting lugs of busbars. When a busbar is connected in the second terminal area, then in practice this virtually precludes inadvertent touching of the second terminal area. Inadvertent touching of the first terminal area is prevented by the terminal cover part which, according to the invention, is riveted to the terminal screw such that it can rotate, and can be driven thereby.

### BRIEF DESCRIPTION OF THE DRAWINGS

The invention as well as further advantageous refinements and improvements of the invention will be explained and described in more detail with reference to the drawings, which illustrate four exemplary embodiments of the invention, and in which:

FIG. 1 shows, schematically, the external view of a service switching device according to the invention,

FIG. 2 shows, schematically, a section view of a first embodiment of a connecting terminal according to the invention,

FIG. 3 shows, schematically, an enlarged illustration of the terminal screw with the terminal cover part riveted on such that it can rotate, as shown in FIG. 2,

FIG. 4 shows a further embodiment of the invention, in which the terminal cover part is composed of metal, and that face which can be touched from the outside in the installed state is covered with insulating material,

FIG. 5 shows a further embodiment of the invention, in which the terminal cover part is composed of plastic and is riveted to the terminal screw by means of a pressure plate, such that it can rotate,

FIG. 6 shows a further embodiment of the invention, in which the terminal cover part is composed of metal and is covered with a plug-on part composed of insulating material, and

FIG. 7 shows a variant of the configuration of the plug-on part in conjunction with the terminal cover part as shown in FIG. 6.

In the figures, identical components or elements, or components or elements with the same effect, are each provided with the same reference numbers, even when they are in a slightly modified form in different embodiment variants.

### DETAILED DESCRIPTION

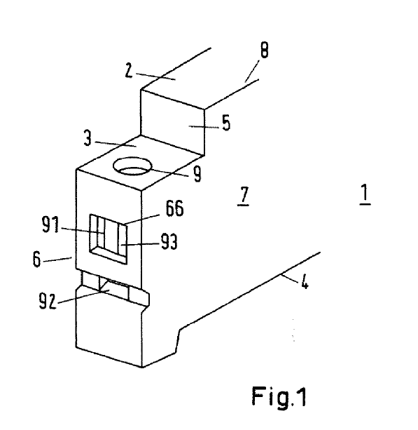

FIG. 1 shows, schematically, a partial view of a service switching device 1 having an insulating-material housing 8 comprising a front front face 2, a rear front face 3, a mounting face 4 opposite the front face, a front narrow face 5 which connects the front and the rear front faces, a rear narrow face 6 which connects the rear front face 3 and the mounting face 4, and two broad faces 7, only one of which can be seen in FIG. 1.

By way of example, the service switching device may be a circuit breaker, a residual current device or the like. Live parts are located in the interior of the insulating-material housing.

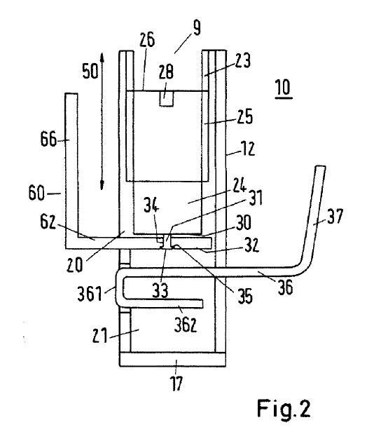

A terminal accommodation area (which cannot be seen here in FIG. 1) is formed in the area between the rear front face 3 and the rear narrow face 6 in the interior of the housing 8 of the service switching device, in which a connecting terminal 10 is held. The connecting terminal is illustrated in detail in FIG. 2.

The connecting terminal 10 comprises a terminal screw 24, which is accessible from the rear front face 3 through a terminal opening 9, as well as a front terminal area 20 and a rear terminal area 21, which are arranged one behind the other seen from the front face and are accessible through a front housing opening 91 and a rear housing opening 92 in the rear narrow face 6 of the housing, for connection of a connecting conductor or of a busbar, or the connecting lug of a busbar.

The first front housing opening 91 has an approximately rectangular contour which extends in the longitudinal direction of the rear narrow face 6, and is used for connection of connecting wires. The second, rear housing opening 92 is incorporated in a step, in the form of a groove, in the rear narrow face 6 and has a transverse rectangular contour. This is intended for clamping on the connecting lug of a busbar.

As will be described in even more detail further below, the terminal screw 24 is coupled to a terminal cover part which is driven in the longitudinal movement direction of the terminal screw thereby and covers the front terminal area 20 on the outside, such that it cannot be touched.

A second limb 66 of this terminal cover part can be seen from the outside with the device housing closed, as shown in FIG. 1. This partially covers the front housing opening 91. An uncovered area 93 of the front housing opening 91 in each case remains free to the left and right of the second limb 66 of the terminal cover part.

The uncovered area 93 is so narrow that it is impossible for a human finger or a standard test finger to pass through the front housing opening 91 in the uncovered area 93 into the interior of the terminal accommodation area, and touch any live parts there.

It would, of course, also be possible to design the terminal cover part or the second limb 66 to be so broad that the front housing opening 91 is covered completely.

The rear housing opening 92 is also so narrow that this effectively prevents a human finger or a test finger from being passed through.

The switching device according to the invention is therefore designed to be proof against direct contact overall.

FIG. 2 shows a schematic section illustration of one embodiment of a connecting terminal 10 according to the invention. This comprises a terminal body 12 which may be cylindrical or else may have an external contour in the form of a box, and has a terminal area in the interior for accommodation of the connecting conductors to be clamped on. The terminal area is closed by a boundary web 17 on the face opposite the terminal opening 9.

In the upper half of the terminal body 12, facing the terminal opening 9, the terminal body 12 has an internal thread 23 into which a terminal screw 24, which has a corresponding external thread 25, can be screwed, and can be screwed in and out in the direction of the direction arrow 50.

The terminal screw 24 has an operating end 26 with a slot 28 for an operating tool, for example a screwdriver, to engage in, and a clamping end 30, which is opposite the operating end 26, by means of which a connecting conductor (not illustrated here) can be clamped firmly by pressure against a busbar 36.

In this case, the slot 28 may have all possible known configurations and profiles for interaction with a multiplicity of known operating tools, for example a cross-headed slot, a pozidrive, a torx profile, or else a combination of different profiles may be used.

In the embodiment illustrated here, the busbar 36 is mounted fixed to the housing in the interior of the terminal area. It subdivides the terminal area into a front terminal area 20 between the busbar 36 and the terminal opening 9, and a rear terminal area 21 between the busbar 36 and the boundary web 17, which bounds the terminal body 12 toward the mounting face 4.

The terminal body 12 is guided in the terminal accommodation area such that it can be moved longitudinally parallel to the narrow face wall. When the terminal screw is screwed in, the clamping end of the terminal screw first of all presses against the conductor which has been inserted in the front terminal area, and clamps this against the busbar. As the terminal screw 24 is screwed in further, it is supported, so to speak, on the busbar 36 and the terminal body 12 is moved upward in the direction of the front face until, finally, the boundary web 17 presses a busbar (not illustrated here), which may have been inserted in the rear terminal area 21, against the busbar 36.

In the device interior, the busbar 36 ends at an outgoer end 37, which forms a connecting conductor and to which further components and assemblies of the service switching device are connected, for example releases or contact points.

At its free end, the busbar 36 is bent in a U-shape thus creating a curved piece 361 and a limb 362 which is adjacent to it and runs parallel to the busbar 36 in the rear terminal area 21. When the connecting lug of a busbar is now inserted into the rear terminal area 21, then it is surrounded on both sides by the limb 362 and the boundary web 17, and a good mechanical and electrical contact is ensured by tightening the terminal screw 24.

In the embodiments illustrated here, the terminal screw 24 is a threaded bolt without a head, also referred to as a grubscrew. This has the advantage that it can be screwed completely in the terminal body 12 without any head projected outward. However, it would, of course, also be possible for a connecting terminal according to the invention to be designed using a screw with a head.

If the clamping end 30 of the terminal screw 24 were to be screwed onto the busbar 36, as is illustrated in FIG. 2, without any connection conductor having been inserted in the front terminal area 20, then, if no further measures were taken, the shank of the terminal screw 24 would be accessible to be touched inadvertently through the front housing opening 91. This situation would also occur in particular in the case of device variants which have a terminal opening with a large cross section for the connection of conductors with a large conductor cross section.

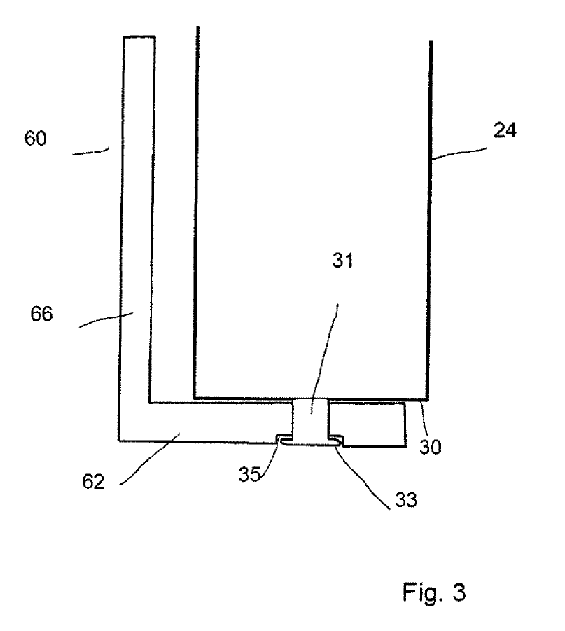

In order to prevent this danger source, a terminal cover part 60 is riveted onto the clamping end 30 of the terminal screw 24, such that it can rotate. FIG. 3 shows an enlarged illustration of the clamping end of the terminal screw 24, with the terminal cover part 60 riveted to it such that it can rotate.

The terminal cover part 60 is approximately L-shaped and is riveted by its first limb 62, the short limb 62, to a rivet pin 31, which projects at the clamping end 30 of the terminal screw, such that it can rotate. The rotatable riveting is known in principle and can be carried out in various ways.

In the present embodiment here, the first limb has an aperture 34 through which the rivet pin 31 passes, and an indentation 35 is provided in the area of the aperture 34. The indentation 35 is of such a size that it accommodates the flange or compressed area 33, which is created during the riveting process at the free end of the rivet pin 31, such that these do not project downwards beyond the first limb 62 in the direction of a connecting conductor which is to be clamped on. This has the advantage that no wear occurs to the connecting conductor when the conducting conductor is pushed on, and instead of this the connecting conductor is pressed on over a large area and flat.

In this case, for example, the riveting process can be carried out with distance control, in such a way that the rivet bead 33 leaves a certain clearance in the contact area with the first limb 62, and the terminal screw 24 can thus rotate relative to the terminal cover part 60.

Because of the rotatable riveted connection in the movement direction 50 of the terminal screw 24, the terminal cover part 60 is in each case driven by the terminal screw 24 which is being screwed in and out.

A second limb 66, in the form of a plate, runs approximately at right angles to the first limb 62 of the terminal cover part 60. The limb 66, in the form of a plate, covers that part of the front terminal area 20 which is located above the clamping end 30 of the terminal screw 24, from the side of the front housing opening 91, such that it cannot be touched.

The connecting terminal 10 according to the invention, with the terminal cover part 60, is fitted in the terminal accommodation area such that the second limb 66, in the form of a plate, of the terminal cover part 60 is guided parallel to the profile of the rear narrow face 6 in the region of the front housing opening 91 on the inside of the housing wall. This prevents the terminal cover part from being damaged by incorrect handling of the service switching device.

The terminal cover part 60 is composed of an insulating material, for example of plastic. When the terminal cover part 60 is pressed onto a connecting conductor, which is not illustrated here, the electrical contact is made between the connecting conductor and the terminal screw on the rivet bead 33. In addition, the connecting conductor can also come into contact in places with the plastic of the first limb 62.

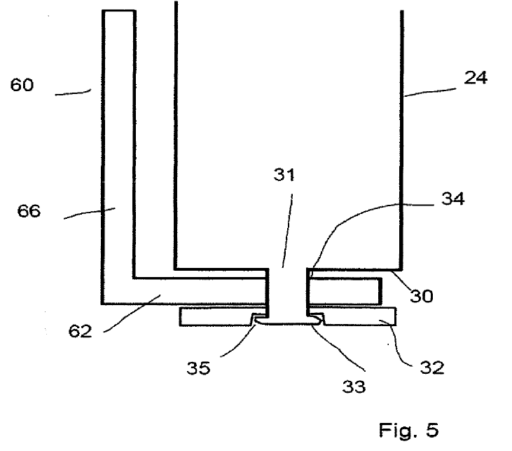

FIG. 5 shows an alternative embodiment of rotatable riveting of the plastic terminal cover part 60 to the terminal screw 24. This variant is used when it is undesirable for the connecting conductor to touch the first limb 62 of the terminal cover part, for example when the intention is to prevent the plastic limb 62 from pressing on the connecting conductor. In this case as well, the rivet pin 31 is passed through an aperture 34 in the first limb 62 of the terminal cover part 60. A metallic pressure plate 32 is fitted on that side of the first limb 62 of the terminal cover part 60 which faces away from the clamping end 30, in such a way that the terminal cover part is riveted by means of the pressure plate 32 to the clamping end 30 of the terminal screw 24. This ensures a large-area metal contact between the terminal screw and a firmly clamped connecting conductor.

The rotatable rivet is provided between the rivet pin 31 and the pressure plate 32 analogously to the process described above. In this case, the indentation for flush accommodation of the rivet bead 33 is incorporated in the pressure plate 32.

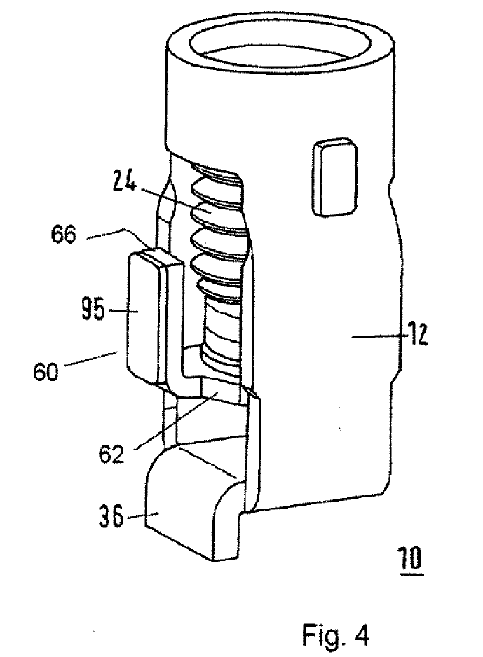

FIG. 4 shows a further embodiment in which the terminal cover part 60 is in the form of a sheet-metal bracket. Its first limb is riveted to the terminal screw, at its clamping end, such that it can rotate. The rotatable riveting of the first limb 62 of the terminal cover part 60 to the rivet pin is in this case carried out in an analogous manner to that described above with reference to FIG. 3.

The sheet-metal bracket is covered with an insulating material on the side which can be touched from the outside in the installed state, and is thus provided with an insulating layer 95 on this side. By way of example, this may be a sprayed-on plastic layer. The terminal cover part is therefore very robust and can be produced at low cost. As can also be seen from FIG. 4, the second limb 66 of the terminal cover part, with the insulating layer 95 applied to it, is narrower than the first limb 62.

It would, of course, also be possible for the second limb 66 of the terminal cover part to be extrusion-coated with plastic on both sides or on all sides.

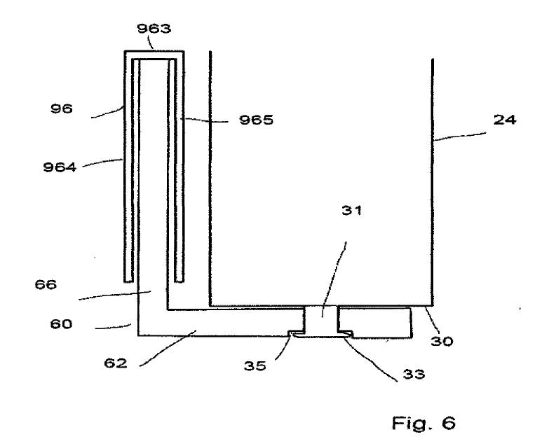

Reference will now be made to FIG. 6. It shows a further possible way to design the second limb of a metallic terminal cover part with little effort but such that it cannot be touched. A U-shaped plug-on part 96 is pushed over the second limb 66 for this purpose. The second limb 66 of the terminal cover part 60 is therefore held as if in a case, and is covered with insulating material, at least on its broad faces.

The U-shaped plug-on part 96 has two longitudinal limbs 964, 965, which are fitted to a transverse web 963. The longitudinal limbs 964 are of such a size that, when the terminal is in the installed position, they completely cover that part of the broad face of the second limb 66 of the terminal cover part 60 which can be touched from the outside through the front housing opening 91. When viewed from the outside, a service switching device having a terminal with a plugged-on plug-on part therefore presents an image which corresponds to that shown in FIG. 1.

The plug-on part 96 can be designed such that it also covers the second limb 66 of the terminal cover part 60 on its narrow faces. It can also be designed such that the narrow faces are not covered since these are inaccessible, or are accessible only with great difficulty, to be touched from the outside through the front housing opening 91.

That limb 965 of the plug-on part which points toward the interior of the terminal body in the plugged-on state can be designed to be precisely as long as the limb 964 which covers the broad face, which can be touched, of the second limb. However, it may also be shorter, and in the extreme case may be shortened to be in the form of a holding claw. Its main function is that of fixing the plug-on part.

By way of example, the plug-on part 96 can be fixed on the second limb 66 in the form of an interference fit.

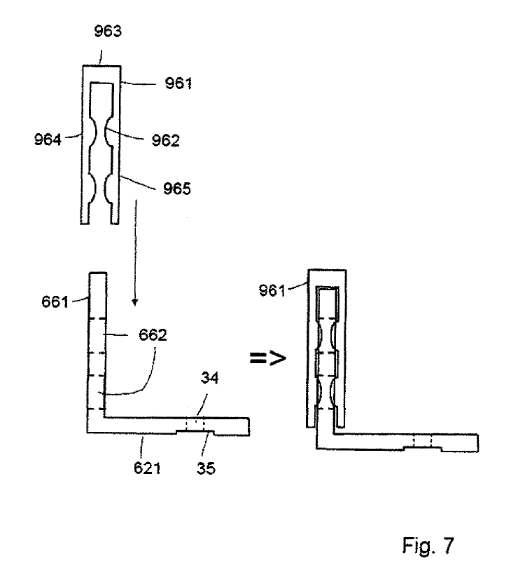

In addition, as is shown in FIG. 7, the plug-on part can also be fixed on the second limb by clipping it on. In this case, the plug-on part 961 is in each case fitted on the insides of the two limbs 964, 965 with studs which project inwards, or with latching means 962 which act in a similar manner but are configured in a different way. The second limb 661 of the terminal cover part has depressions or aperture holes 662 at points which correspond, when the plug-on part is plugged on, to the studs 962 or the latching means which have the same function but are designed in a different manner.

When the plug-on part 961 is plugged on, indicated by the direction arrow on the left-hand side of FIG. 7, this then latches in the depressions or aperture holes 662. The latched-on state is illustrated on the right-hand side of FIG. 7. This prevents the plug-on part 961 which has been plugged onto the second limb 661 from sliding or moving, even when the plug-on part is open on the narrow faces.

A further embodiment, which is not illustrated in the figures, comprises the second limb 66 of the terminal cover part being covered with an insulating shrink sleeve, which is then attached to the terminal cover part in a captive manner by being shrunk on in a known manner, for example by heating.

### LIST OF REFERENCE SYMBOLS

1 Service switching device
2 Front front face
3 Rear front face
4 Mounting face
5 Front narrow face
6 Rear narrow face
7 Broad face
8 Housing
9 Terminal opening
10 Connecting terminal
12 Terminal body
17 Boundary web
20 Front terminal area
21 Rear terminal area
23 Internal thread
24 Terminal screw
25 External thread
26 Operating end of the terminal screw
28 Operating slot
30 Terminal end of the terminal screw
31 Rivet bead
32 Pressure plate
33 Rivet compression
34 Aperture
35 Indentation
36 Busbar
361 Curve piece
362 Limb of the busbar
37 Outgoer end of the busbar
50 Movement direction of the terminal screw
60 Terminal cover part
62 First limb of the terminal cover part
621 First limb of the terminal cover part
66 Second limb
661 Second limb
662 Recess
91 Front housing opening
92 Rear housing opening
93 Uncovered area
95 Insulating layer
96 Plug-on part
961 Plug-on part
962 Stud-like outward bulge
963 Web
964 Limb
965 Limb

1-21. (canceled)

22. A service switching device comprising:
a housing having a front face, a mounting face, and a narrow face disposed between the front face and the mounting face; and
a connecting terminal disposed in a terminal accommodation area close to the narrow face having:
a terminal screw, accessible from the front face and moveable in a movement direction, including an operating end and a clamping end disposed opposite the operating end;
a terminal body including at least one terminal area, in which a connecting conductor can be pressed against a busbar by the terminal screw, wherein the terminal body is accessible via a first housing opening in a wall of the narrow face; and
a terminal cover part riveted to the screw clamping end in a rotatable manner and driveable in the movement direction and covering the at least one terminal area in a touch-proof manner when the terminal screw is in a clamped position relative to the busbar.

23. A service switching device comprising:
a housing having a front face, a mounting face, and a narrow face disposed between the front face and the mounting face; and
a connecting terminal disposed in a terminal accommodation area close to the narrow face having:
a terminal screw, accessible from the front face and moveable in a movement direction, including an operating end and a clamping end disposed opposite the operating end;
a terminal body including at least two terminal areas accessible via a first and a second housing opening in a wall of the narrow face adjacent to the front face, the two terminal areas disposed one behind the other with respect to the front face and separated from one another by a busbar insertable into the terminal body, and configured to enable a clamping connection of a connecting conductor with the busbar; and
a terminal cover part riveted to the screw clamping end so as to be rotatable, wherein the terminal cover part is driveable in the movement direction by the screw clamping end and covers one of the at least two terminal areas disposed between the busbar and the front face when the terminal screw is screwed onto the busbar.

24. The service switching device as recited in claim 22, wherein the terminal cover part is L-shaped, having a first limb riveted to the screw clamping end and a second limb in a direction of the front face from the first limb and covering the terminal area in the touch-proof manner.

25. The service switching device as recited in claim 24, wherein the second limb is narrower than the first housing opening, wherein a part of the first housing opening is free of the terminal cover part and having a size that is small enough to prevent a live device part from passing through it.

26. The service switching device as recited in claim 24, wherein the terminal cover includes plastic.

27. The service switching device as recited in claim 26, wherein the terminal cover part includes to a metallic rivet plate and is riveted by a rivet pin projecting at the screw clamping end.

28. The service switching device as recited in claim 24, wherein the terminal cover part includes a metal, wherein at least the second limb is coverable with an insulating material at least on a touchable face pointing outwards.

29. The service switching device as recited in claim 28, wherein a plastic part sheaths the second limb.

30. The service switching device as recited in claim 28, wherein an insulating shrink sleeve is shrunk onto the second limb.

31. The service switching device as recited in claim 28, wherein a touchable face includes at least one of a spray-on plastic and an insert-molded plastic.

32. The service switching device as recited in claim 22, wherein the terminal screw includes a threaded bolt without a head.

33. A connecting terminal for installation in a terminal accommodation area of a service switching device with a housing, the connecting terminal comprising:
a terminal screw having an operating end and a screw clamping end disposed opposite the operating end and moveable in a movement direction;
a terminal body having at least one terminal area, wherein a connecting conductor is pressable against a busbar by the terminal screw; and
a terminal cover part covering the at least one terminal area in a touch-proof manner and riveted in a rotatable manner to the screw clamping end, the terminal cover part being driveable in the movement direction by the screw clamping end.

34. The connecting terminal as recited in claim 33, wherein the at least one terminal area includes at least two terminal areas disposed one behind the other with respect to the movement direction and separated from one another by the connecting conductor insertable into the terminal body, and configured to enable connection of the connecting conductor to the busbar, wherein one of the at least two terminal areas is disposed between the busbar and the screw clamping end and the terminal cover part covers one of the at least two terminal areas when the terminal screw is screwed onto the busbar.

35. The connecting terminal as recited in claim 33, wherein the terminal cover part is L-shaped, having a first limb riveted to the screw clamping end and a second limb in a direction of the front face from the first limb and covering the terminal area in the touch-proof manner.

36. The connecting terminal as recited in claim 35, wherein the second limb is narrower than the first housing opening, wherein a part of the first housing opening is free of the terminal cover part and having a size that is small enough to prevent a live device part from passing through it.

37. The connecting terminal as recited in claim 33, wherein the terminal cover part includes plastic.

38. The connecting terminal as recited in claim 37, wherein the terminal cover part includes to a metallic rivet plate and is riveted by a rivet pin projecting at the screw clamping end.

39. The connecting terminal as recited in claim 38, wherein the terminal cover part includes a metal, wherein at least the second limb is coverable with an insulating material at least on a touchable face pointing outwards.

40. The connecting terminal as recited in claim 39, wherein a plastic part sheaths the second limb.

41. The connecting terminal as recited in claim 39, wherein an insulating shrink sleeve is shrunk onto the second limb.

42. The connecting terminal as recited in claim 39, wherein a touchable face includes at least one of a spray-on plastic and an insert-molded plastic.
